(19) United States
(12) Patent Application Publication
(10) Pub. No.: US 2012/0316791 A1
(43) Pub. Date: Dec. 13, 2012

(54) SYSTEM AND METHOD FOR SEISMIC DATA INVERSION BY NON-LINEAR MODEL UPDATE

(75) Inventors: Nikhil Koolesh Shah, Stanmore (GB); John Kenneth Washbourne, Walnut Creek, CA (US)

(73) Assignee: Chevron U.S.A. Inc., San Ramon, CA (US)

(21) Appl. No.: 13/156,202

(22) Filed: Jun. 8, 2011

(51) Int. Cl. G06F 19/00

(52) U.S. Cl. 702/14

(57) ABSTRACT

A system and computer-implemented method for determining properties of a subsurface region of interest from seismic data is disclosed. An embodiment of the method performs full waveform inversion by non-linear model update to compute a velocity model. The method includes obtaining actual seismic data representative of the subsurface region and an initial earth property model for the subsurface region, performing forward modeling using the initial earth property model to create modeled seismic data with similar acquisition specifications as the actual seismic data, calculating a residual between the actual seismic data and the modeled seismic data in a time or transform domain, and inverting the residual to generate a model produced by non-linear model update components. The system includes a data source, user interface, and processor configured to execute computer modules that implement the method.

### FIELD OF THE INVENTION

The present invention relates generally to methods and systems for inverting seismic data to compute physical properties of the earth's subsurface, and in particular methods and systems for performing full waveform inversion by non-linear model update to compute velocity models from seismic data.

### BACKGROUND OF THE INVENTION

Subsurface exploration, and in particular exploration for hydrocarbon reservoirs, typically uses methods such as migration of seismic data to produce interpretable images of the earth's subsurface. In areas where the subsurface is complex due to faulting, salt bodies and the like, traditional migration methods often fail to produce adequate images. Additionally, traditional migration methods require a reasonably accurate velocity model of the subsurface; such velocity models may also be determined from the seismic data but may be very expensive in both expertise and computational cost.

There are many conventional methods for computing velocity models from seismic data, including NMO velocity analysis, migration velocity analysis, tomography, and full waveform inversion. Some methods, such as full waveform inversion, are very computationally expensive and have only recently become practical as computing power has increased. Conventional full waveform inversion is done in the time domain or in a transform domain such as the temporal Fourier transform domain or the Laplace transform domain. These methods often fail due to the lack of low frequencies, typically less than 3 Hertz, in seismic data. As one skilled in the art will appreciate, a velocity model is a low frequency model so it is difficult to invert for it from the seismic data that lacks the low frequency information.

Traditional methods of determining velocity models and using them for migration to produce images of the earth's subsurface are expensive and fraught with difficulties, especially in complex areas. As the search for hydrocarbons moves to these complex areas, it is necessary to find better ways to process the seismic data and improve velocity models.

### SUMMARY OF THE INVENTION

According to one implementation of the present invention, a computer-implemented method for determining properties of a subsurface region of interest, the method includes obtaining actual seismic data representative of the subsurface region and an initial earth property model for the subsurface region, performing forward modeling using the initial earth property model to create modeled seismic data with similar acquisition specifications as the actual seismic data, calculating a residual between the actual seismic data and the modeled seismic data in a time or transform domain, and inverting the residual to generate a model produced by non-linear model update components.

The method may also be implemented such that the non-linear model update components are derived from an inverse scattering series of a forward modeling equation. Additionally, the residual may be expressed in terms of an unwrapped phase.

In an embodiment, a system for performing the method includes a data source, user interface, and processor configured to execute computer modules that implement the method.

In another embodiment, an article of manufacture comprising a computer readable medium having a computer readable code embodied therein, the computer readable program code adapted to be executed to implement the method is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, pending claims and accompanying drawings where:

FIG. 1 is a flowchart illustrating a method of full waveform inversion;

FIG. 2 illustrates gradient bandwidths at various frequencies;

FIG. 3 illustrates a conventional full waveform inversion process beginning from a good initial earth properties model;

FIG. 4 illustrates a conventional full waveform inversion process beginning from a poor initial earth properties model;

FIG. 5 is a flowchart illustrating a method in accordance with an embodiment of the invention; and

FIG. 6 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple computer processors, hand-held devices, programmable consumer electronics, mini-computers, mainframe computers, and the like. The invention may also be practiced in distributed computing environments where tasks are performed by servers or other processing devices that are linked through a one or more data communications network. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

The present invention relates to computing physical properties of the earth's subsurface and, by way of example and not limitation, can compute a velocity model using full waveform inversion based on applying model updates with components that are non-linear in the data.

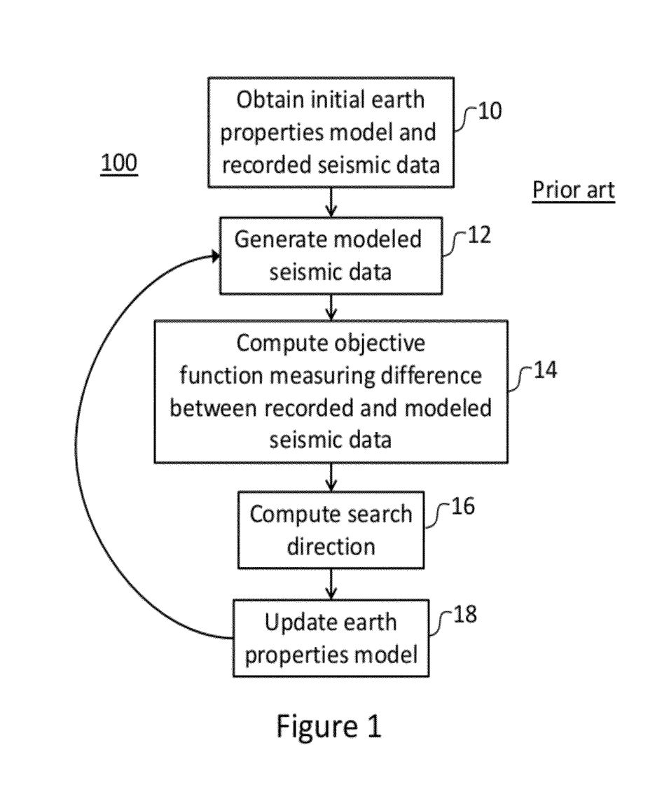

To begin the explanation of the present invention, first consider the basic, prior art full waveform inversion method 100 illustrated in the flowchart of FIG. 1. At step 10, an initial model of earth properties is obtained such as, by way of example and not limitation, velocity. Full waveform inversion is a local optimization method and therefore depends strongly on where the optimization starts. For conventional full waveform inversion, there is a strict condition on the initial model in terms of what is required for the nonlinear evolution to converge to a true solution: the initial model must generate data that is within half a wave-cycle of the observed data at the lowest usable temporal frequency. It is important to note that with this conventional approach there is no easy way to determine if the initial model meets this condition and the optimization can easily fail with a poor initial model.

In step 12, the initial model of earth properties is used by a seismic modeling engine to generate modeled seismic data. In general modeling can be performed in either the time domain or the frequency domain (temporal Fourier transform) with no penalty, depending on various factors like the size/extent of the modeling domain and the amount of memory available. Large 3D surveys typically require time-domain modeling because frequency domain modeling is extremely memory intensive for large numbers of model parameters. One significant advantage of frequency domain modeling is that one directly has access to both amplitude and phase, and this allows the use of “phase only” approaches that can be geared to be dominated by kinematics instead of amplitudes.

In step 14, we compute an objective function that will measure the misfit between the recorded seismic data and the modeled seismic data. The most widely used objective function for conventional full waveform inversion is simple least squares: the sum of the squares of the differences between the observed data and the modeled data for all sources, receivers and recorded time samples. However, this is not meant to be limiting; other objective functions can be used including correlation, the L1 norm, and hybrid or long-tailed norms. The objective function may be constructed in the time domain or in a transform domain such as the frequency domain.

In the time domain, the least squares objective function may take the form:

$$E = \frac{1}{2} {\sum }_{s} {\sum }_{r} {\sum }_{t} {[ {ψ}_{obs} ( t , r , s ) - {ψ}_{mod} ( t , r , s ) ]}^{2} \qquad Eqn . 1$$

where E is the objective function, s are the sources, r are the receivers, t is time, ψ_{obs} is the recorded data, and ψ_{mod} is the modeled data. This objective function suffers from the critical flaw that seismic data is bandlimited. Differencing of bandlimited signals introduces the possibility of “cycle skipping”, where the wave shapes of the modeled and observed data are similar enough to cause a small difference, but are misaligned in an absolute sense by (at least) one wave cycle. This, together with the local nature of full waveform inversion, leads to the likely possibility that the nonlinear optimization will fail and converge to a local minima rather than the global solution.

One way to change the characteristics of the problem is to change the objective function. If we transform to the frequency domain we can consider objective functions at one or more frequency components individually (monochromatically). In the time domain, we cannot consider a single time sample because of dependence on earlier times. In the frequency domain, the response at different frequencies is uncoupled: the solution at one frequency does not depend on the solution at any other frequency. We can also, importantly, treat amplitude and phase differently. Taking the temporal Fourier transform of Eqn. 1, the objective function becomes:

$$E ( ω ) = \frac{1}{2} {\sum }_{s} {\sum }_{r} {\vert {A}_{obs} ( ω , r , s ) {e}^{i {ϕ}_{obs} ( ω , r , s )} - {A}_{mod} ( ω , r , s ) {e}^{i {ϕ}_{mod} ( ω , r , s )} \vert}^{2} \qquad Eqn . 2$$

where A_{obs}(ω,r,s) is the amplitude of the observed data at receiver r, from source s, at temporal frequency ω, φ_{obs}(ω,r,s) is the phase of the observed data, A_{mod}(ω,r,s) is the amplitude of the modeled data, and φ_{mod}(ω,r,s) is the phase of the modeled data.

In the frequency domain, we can consider the phase portion independently of the amplitude portion. For the phase-only case of full waveform inversion, by way of example and not limitation, the least squares objective function becomes:

$$E ( ω ) = \frac{1}{2} {\sum }_{s} {\sum }_{r} {\vert {ϕ}_{obs} ( ω , r , s ) - {ϕ}_{mod} ( ω , r , s ) \vert}^{2} . \qquad Eqn . 3$$

The modeled data in Eqns. 1-3 may be generated in the time or the frequency domain. The objective functions of Eqns. 1-3 measure the mismatch between the observed and modeled data and are decreased at each iteration. The inversion may be done as a phase-only inversion in either the time or frequency domain, as long as the mismatch can be measured directly or indirectly in terms of the phase of one or more frequency components.

Once the objective function is computed in step 14 of FIG. 1, a search direction is computed in step 16. In order to update the earth properties model and reduce the misfit between the observed and modeled data, the gradient of the objective function is used to generate a search direction for improving the model. The earth properties model is then iteratively perturbed along successive search directions until some satisfaction criteria are reached.

The calculation of the search direction becomes more understandable if we treat the modeled data as the action of a nonlinear seismic modeling operator on the earth property model. Using the example of velocity (v) as the earth property, the operator being nonlinear means that a linear change in velocity does not necessarily result in a linear change in the modeled data.

Using the symbol N to represent the nonlinear seismic modeling operator that maps velocity models into seismic data, and the action of this operator on the current velocity model as N(v), we can rewrite Eqn. 1:

$$E = \frac{1}{2} {\sum }_{s} {\sum }_{r} {\sum }_{t} {[ {ψ}_{obs} ( t , r , s ) - N ( v ) ]}^{2} \qquad Eqn . 4$$

so the derivative with respect to velocity becomes:

$$\frac{\partial }{\partial v} E = - {\sum }_{s} {\sum }_{r} {\sum }_{t} ( [ {ψ}_{obs} ( t , r , s ) - N ( v ) ] \frac{\partial }{\partial v} N ( v ) ) . \qquad Eqn . 5$$

Eqn. 5 shows that the derivatives used to update the earth property model depend very importantly on the modeling operator, the derivatives of the modeling operator with respect to velocity, and the current seismic data residual. Such a model update is linear in the data.

The nonlinear problem of full waveform inversion is solved by successive linearization. For the example of inverting for velocity, at iteration k, this is done by linearizing around the velocity v^{(k)}, and seeking an update to the velocity δv, such that the updated model is: v^{(k+1)}=v^{(k)}+δv. We need the linearization in order to compute the search direction. Given the general linear least squares system:

E=∥y−Ax∥² Eqn. 6

The gradient or search direction can be written:

$$\frac{\partial }{\partial x} E = {A}^{†} [ y - Ax ] . \qquad Eqn . 7$$

Where A^{†} is the adjoint (conjugate transpose) of the linear operator A. For our nonlinear problem of full waveform inversion, we have the nonlinear modeling operator N, and we need the adjoint of the linearized modeling operator in order to compute a gradient. We use L for the linearized modeling operator, and L^{†} for the adjoint of the linearized operator. The operator L maps a vector of velocity perturbations into a vector of wavefield perturbations, and the adjoint operator L^{†} maps a vector of wavefield perturbations into a vector of velocity perturbations (Eqn. 8).

Lδv₁=δψ₁

L^{†}δψ₂=δv₂ Eqn. 8

Once the search direction is computed, we need to determine how large a step to take in that direction, which is how the earth properties model is updated in step 18 of FIG. 1. At least two alternatives exist: a nonlinear line search or solving the linear problem using, by way of example and not limitation, a Gauss-Newton methodology.

The majority of published conventional approaches employ steepest descent or preconditioned steepest descent for nonlinear optimization. Once the search direction is estimated, these approaches forget about the current linear problem and use a nonlinear line search to estimate the best “step size” to take in the search direction. If we use αv for the search direction (usually the gradient of the objective function with respect to the velocity parameters), and α for the step size, we can express the nonlinear line search as:

$${min}_{∝} \{ \frac{1}{2} {\sum }_{s} {\sum }_{r} {\sum }_{t} {[ {ψ}_{obs} ( t , r , s ) - N ( v + ∝ δ v ) ]}^{2} \} . \qquad Eqn . 9$$

One serious shortcoming of a nonlinear line search is taking such a large step that the modeled data becomes cycle skipped with respect to the observed data. This could result in a smaller residual and lead to convergence to a local minimum rather than the true global solution.

An alternative to using a nonlinear line search is to solve the linear problem at each successive linearization of the nonlinear evolution. Solving the linear problem obviates the need for a line search as the step size selection is implicit in the implementation of linear optimization, as in for example the conjugate gradient method. Solving the linear problem requires accurate machinery of the linearization: forward and adjoint linearized operators that pass the adjoint test. This often requires significant work, but can result in significant improvements in convergence. Using the linearized operators L and L^{†} described above, we can solve the linear system using, by way of example and not limitation, conjugate gradient on the normal equations. The linear system we want to solve is:

min∥Lδv−δψ∥² Eqn. 10

where δψ is the current residual δψ=ψ_{obs}−N(vₖ).

Referring again to FIG. 1, after the earth property model has been updated, the process loops back to step 12 where the updated model is used to generate modeled seismic data. Step 14 is performed and, if the difference between the modeled seismic data and the recorded seismic data is large, steps 16 and 18 are also performed and looped back to step 12, until the difference at step 14 is sufficiently small or the number of loops or iterations reaches a predefined number.

When attempting this conventional full waveform inversion, method 100 of FIG. 1 has serious limitations. First, full waveform inversion is a local optimization method, which means it is sensitive to where the nonlinear evolution starts. If the initial model is far from the true model, local approaches fail. This problem impacts all local methods, including Newton and quasi-Newton methods. For conventional full waveform inversion, it is absolutely critical to obtain a good starting model. In general, there are no obvious ways to determine quantitatively if a given starting model will converge to the true global minimum.

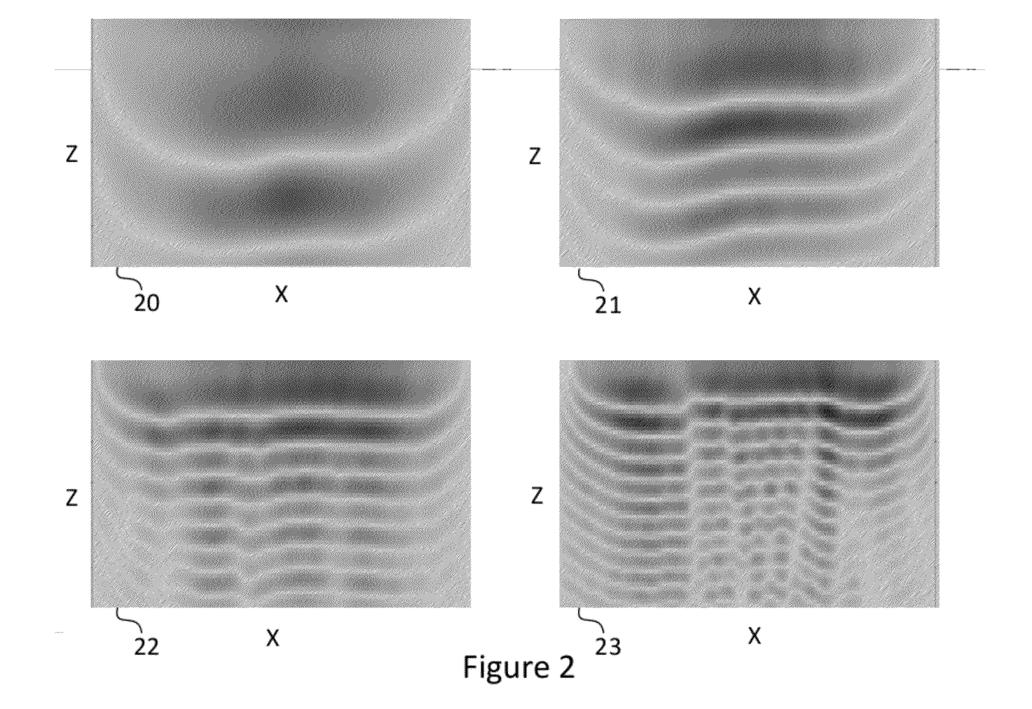

Another serious limitation of conventional full waveform inversion is the bandwidth limitation. There is a direct relationship between the temporal bandwidth of data used to generate a gradient (search direction) and the spatial bandwidth of the gradient obtained by evaluation of Eqn. 5. Low temporal frequencies in the data produce long spatial wavelengths in the gradient. Consider FIG. 2, which demonstrates this by plotting gradients in spatial X and Z coordinates computed at four frequencies. Note that at the lowest frequency of 0.5 Hz (panel 20) the calculated gradient is much less spatially oscillatory. At 1 Hz (panel 21), 1.5 Hz (panel 22), and 2 Hz (panel 23), the gradient becomes progressively more oscillatory. The bandwidth of seismic data is limited, and if correct long spatial wavelengths of velocity do not exist in the initial model, conventional full waveform cannot recover them and in general will fail and converge to a local minimum rather than the true global solution. This directly implies we should invert seismic data at the lowest usable frequency, in order to employ gradients that modify the long spatial wavelengths of velocity. However, the lowest usable frequency is seismic data is often not low enough to recover the longest spatial wavelengths and leads to a global minimum—this is a key limiting factor of the prior art which the present invention addresses.

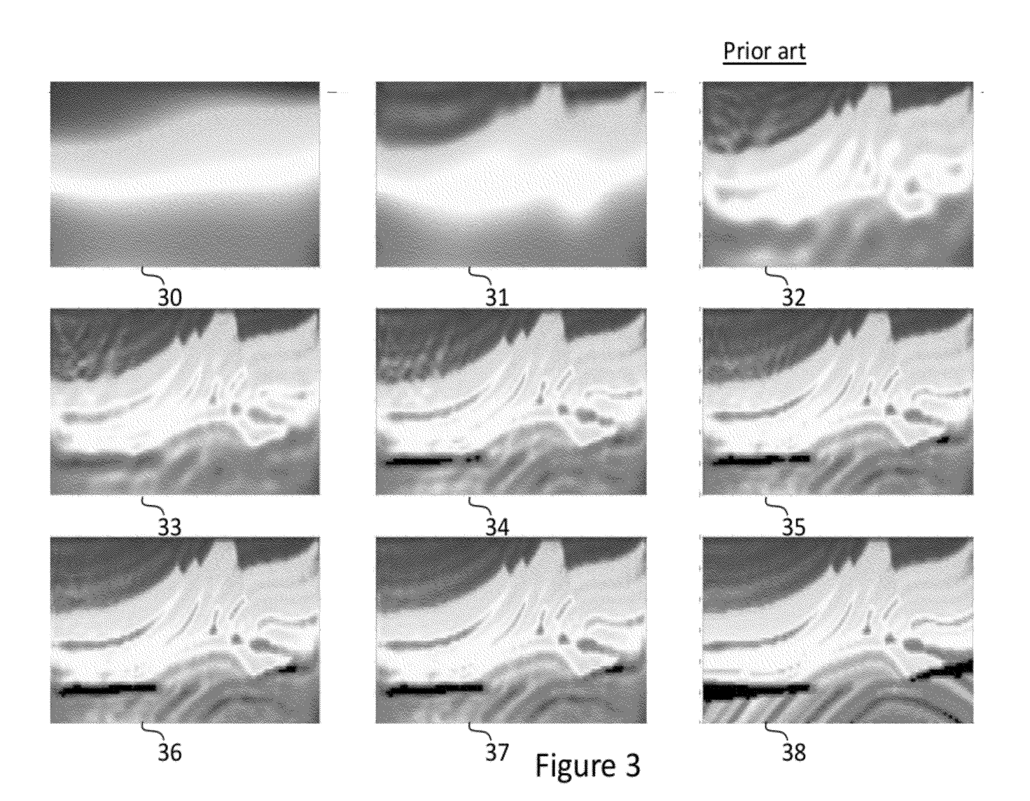

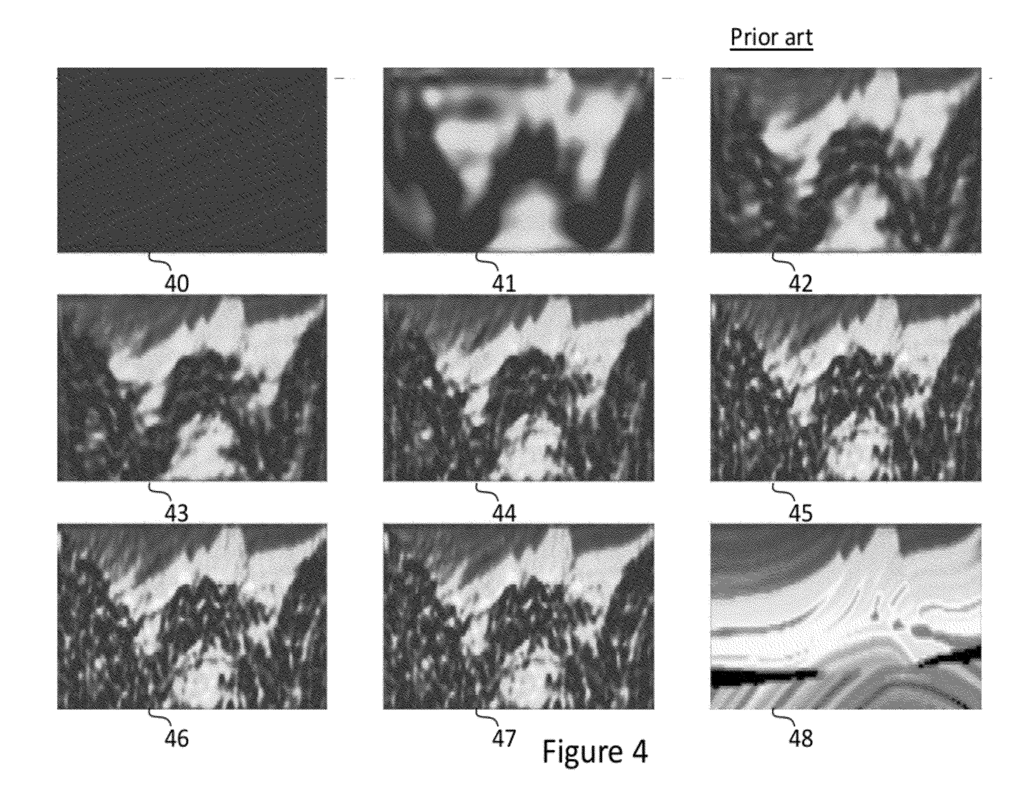

Examples of the importance of the initial earth properties model for a conventional full waveform inversion can be seen in FIGS. 3 and 4. In FIG. 3, the initial velocity model can be seen in panel 30. It is a smoothed version of the true velocity model which is in panel 38. Panels 31-37 show the result of conventional full waveform inversion at 8 successive frequencies: 1, 3, 5, 7, 9, 11, and 13 Hz. The final result in panel 37 is quite accurate when compared with the true velocity model in panel 38.

In FIG. 4, the initial velocity model in panel 40 is constant and is set to be water velocity. This is far from the true velocity model in panel 48. Panels 41-47 show the result of conventional full waveform inversion at 8 successive frequencies: 1, 3, 5, 7, 9, 11, and 13 Hz. While the uppermost part of the model is accurately recovered, the deeper parts have converged to a local minimum that is very far from the true solution. We can conclude from FIGS. 3 and 4 that conventional full waveform inversion must have a good initial earth properties model to converge to the correct solution.

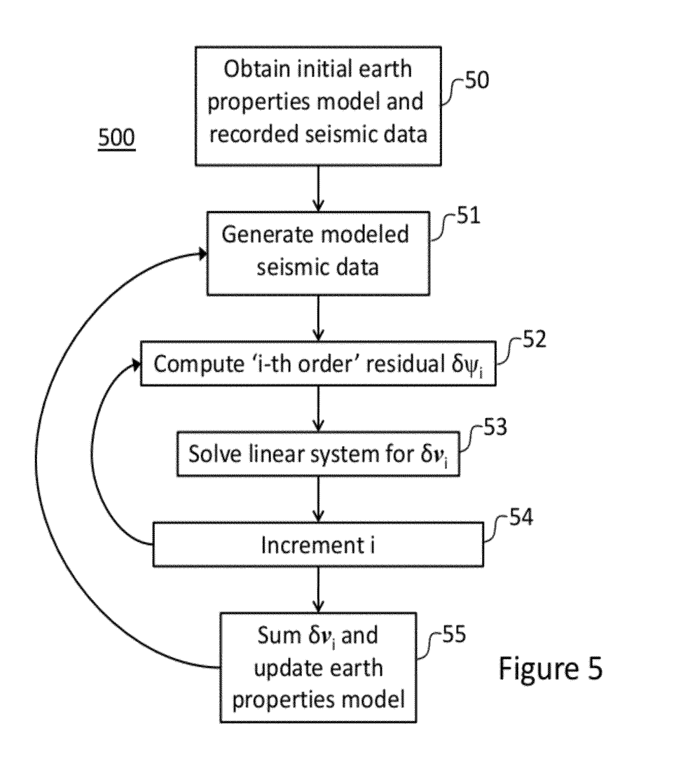

As shown in FIG. 5, the present invention (method 500) uses non-linear model updates to lessen this restriction on a good starting model. Conventional iterative full waveform inversion uses only the first order equation of Eqn. 10: it solves for δv, updates the reference model, re-linearizes, and solves the first order equation again. In the present invention, we solve for a model update with higher-order components: δv=δv₁+δv₂+δv₃+ . . . +δvₙ (step 55). Here, δvᵢ is dependent on the i-th power of the residual (step 52 and incremented at step 54) (in conventional FWI the model update is the first term of such a series). In one formulation, we derive model update components from multiple equations that take the form of equation 10:

min∥Lδvᵢ−δψᵢ∥² Eqn. 11

where L is linearized form of forward modeling operator N and δψᵢ are inputs into the system calculated from the data residual (step 53). One way to calculate these inputs δψᵢ is through scattering theory. This process is now described as applied to the case where N is the Helmholtz wave equation operator shown in Eqn 12:

$$( {∇}^{2} + \frac{{ω}^{2}}{{v ( x )}^{2}} ) ψ ( x , ω ) = S ( x , ω ) \qquad Eqn . 12$$

where ∇² is the Laplacian operator which in two dimensions is

$$\frac{{\partial }^{2}}{\partial {x}^{2}} + \frac{{\partial }^{2}}{\partial {z}^{2}} ,$$

ω is circular frequency, v is the velocity model, ψ is the wavefield in space x and frequency, and S is the source in space and frequency. This equation governs the generation of the true and reference wavefields ψ and ψ₀ by wave propagation in the true and reference velocity models v and v₀ at angular temporal frequency ω, due to an impulsive source δ (a more specific S).

Using the symbols s for a source location, r for a receiver location, and x for a general subsurface coordinate, the Green's function notation ψ(x,s) describes propagation from the source location s to the subsurface point x. Similarly, ψ(r,x) describes propagation from the subsurface location x to the receiver location r. δ(x−x′) is a dirac delta function at subsurface point x′. This then leads us to the Helmholtz equations for our true and reference wavefields:

$$( {∇}^{2} + \frac{{ω}^{2}}{{v ( x )}^{2}} ) ψ ( x , s ) = δ ( x - s ) \\ ( {∇}^{2} + \frac{{ω}^{2}}{{{v}_{0} ( x )}^{2}} ) {ψ}_{0} ( x , s ) = δ ( x - s ) \qquad Eqn . 13 a , 13 b$$

We now introduce a spatially varying velocity perturbation Δv(x) that defines the difference between the true model v and the reference model v₀:

$$\frac{{ω}^{2}}{{v ( x )}^{2}} = \frac{{ω}^{2}}{{{v}_{0} ( x )}^{2}} ( 1 - \frac{2 Δ v ( x )}{{v}_{0} ( x )} ) = \frac{{ω}^{2}}{{{v}_{0} ( x )}^{2}} - \frac{2 {ω}^{2} Δ v ( x )}{{{v}_{0} ( x )}^{3}} \qquad Eqn . 14$$

Subtracting Eqn. 13b from Eqn. 13a and defining the scattered wavefield as the difference between the true wavefield and the reference wavefield: ψ_{scat}(x,s)=ψ(x,s)−ψ₀(x,s); we get:

$$( {∇}^{2} + \frac{{ω}^{2}}{{{v}_{0} ( x )}^{2}} ) {ψ}_{scat} ( x , s ) = ψ ( x , s ) \frac{2 {ω}^{2} Δ v ( x )}{{{v}_{0} ( x )}^{3}} \qquad Eqn . 15$$

and the exact expression for the scattered wavefield is:

$${ψ}_{scat} ( x , s ) = {( {∇}^{2} + \frac{{ω}^{2}}{{{v}_{0} ( x )}^{2}} )}^{- 1} ψ ( x , s ) \frac{2 {ω}^{2} Δ v ( x )}{{{v}_{0} ( x )}^{3}} . \qquad Eqn . 16$$

If we now expand Eqn 16 as a sum over subsurface locations x′, we can write:

$${ψ}_{scat} ( x , s ) = {\sum }_{{x}^{′}} [ {( {∇}^{2} + \frac{{ω}^{2}}{{{v}_{0} ( x )}^{2}} )}^{- 1} δ ( x - {x}^{′} ) ψ ( {x}^{′} , s ) \frac{2 {ω}^{2} Δ v ( {x}^{′} )}{{{v}_{0} ( {x}^{′} )}^{3}} ] \qquad Eqn . 17$$

and from Eqn. 13 we recognize the term

$${( {∇}^{2} + \frac{{ω}^{2}}{{{v}_{0} ( x )}^{2}} )}^{- 1} δ ( x - {x}^{′} )$$

as the wavefield in the reference media ψ₀(x, x′):

$${ψ}_{scat} ( x , s ) = {\sum }_{{x}^{′}} [ {ψ}_{0} ( x , {x}^{′} ) \frac{2 {ω}^{2} Δ v ( {x}^{′} )}{{{v}_{0} ( {x}^{′} )}^{3}} ψ ( {x}^{′} , s ) ] . \qquad Eqn . 18$$

This is the Lipmann-Schwinger equation for the scattered wavefield which can be expanded as a series in Δv and ψ₀.

$${ψ}_{scat} ( x , s ) = {\sum }_{{x}^{′}} {ψ}_{0} ( x , {x}^{′} ) \frac{2 {ω}^{2} Δ v ( {x}^{′} )}{{{v}_{0} ( {x}^{′} )}^{3}} {ψ}_{0} ( {x}^{′} , s ) + {\sum }_{{x}^{′}} {\sum }_{{x}^{″}} {ψ}_{0} ( x , {x}^{′} ) \frac{2 {ω}^{2} Δ v ( {x}^{′} )}{{{v}_{0} ( {x}^{′} )}^{3}} {ψ}_{0} ( {x}^{′} , {x}^{″} ) \frac{2 {ω}^{2} Δ v ( {x}^{″} )}{{{v}_{0} ( {x}^{″} )}^{3}} {ψ}_{0} ( {x}^{″} , x ) + … \qquad Eqn . 19$$

The first term is linear in perturbation Δv, the second term is quadratic and so on and so forth. For a given residual δψ, we invert this data-model relationship to obtain the model correction. The model correction is written as δv=δv₁+δv₂+δv₃+ . . . where the i-th model update component δvᵢ is i-th order in the residual and is obtained by equating terms of equal order in equation 19.

1^{st} order:

$$δ ψ ( r , s ) = {\sum }_{{x}^{′}} {ψ}_{0} ( r , {x}^{′} ) \frac{2 {ω}^{2} δ {v}_{1} ( {x}^{′} )}{{{v}_{0} ( {x}^{′} )}^{3}} {ψ}_{0} ( {x}^{′} , s )$$

2^{nd} order:

$${\sum }_{{x}^{′}} {\sum }_{{x}^{″}} {ψ}_{0} ( r , {x}^{′} ) \frac{2 {ω}^{2} δ {v}_{1} ( {x}^{′} )}{{{v}_{0} ( {x}^{′} )}^{3}} {ψ}_{0} ( {x}^{′} , {x}^{″} ) \frac{2 {ω}^{2} δ {v}_{1} ( {x}^{″} )}{{{v}_{0} ( {x}^{″} )}^{3}} {ψ}_{0} ( {x}^{″} , s ) = {\sum }_{{x}^{′}} {ψ}_{0} ( r , {x}^{′} ) \frac{2 {ω}^{2} δ {v}_{2} ( {x}^{′} )}{{{v}_{0} ( {x}^{′} )}^{3}} {ψ}_{0} ( {x}^{′} , s ) \qquad Eqn . 20$$

With the nonlinear modeling operator written as N, the nonlinear system to be solved is ψ_{obs}(x,s)=Nv(x). The first order part of Eqn. 20 is the linearization of this nonlinear system and is equivalent to the model update of one iteration of conventional full waveform inversion. The first two components of the non-linear model update can be written as:

$$δψ ( r , s ) = ( \frac{\partial }{\partial v} N ) δ {v}_{1} \\ {\sum }_{{x}^{′}} {\sum }_{{x}^{″}} {ψ}_{0} ( r , {x}^{′} ) \frac{2 {ω}^{2} δ {v}_{1} ( {x}^{′} )}{{{v}_{0} ( {x}^{′} )}^{3}} {ψ}_{0} ( {x}^{′} , {x}^{″} ) \frac{2 {ω}^{2} δ {v}_{1} ( {x}^{″} )}{{{v}_{0} ( {x}^{″} )}^{3}} {ψ}_{0} ( {x}^{″} , s ) = ( \frac{\partial }{\partial v} N ) δ {v}_{2} \qquad Eqn . 21$$

This means that we can perform the linearization once in the reference medium, then re-use it to successively compute increasing orders (components) of the model update δvₖ. If we use a constant velocity reference medium, we have an analytic solution for the wave equation, meaning that we do not require forward modeling for the model update calculation. If the reference medium is non-constant, we can build the linearization matrix rather than just the ability to apply the matrix or adjoint to a vector. This would be advantageous when many orders are desired. We build the matrix one column at a time using the action of the linearization operator on a succession of delta functions, one for each subsurface location in the model. The model update may be obtained from a residual in the time or frequency domain to enable a split between phase and amplitude.

In the present invention, it may also be desirable to unwrap the first order residual phase. Phase unwrapping ensures that all appropriate multiples of 2π have been included in the phase portion of the data, meaning that the phase is continuous rather than jumping by 2π. There are methods for phase unwrapping but many fail for even moderate frequencies such as those greater than 2 Hz. Due to this, the inventors have developed a new method for phase unwrapping to prepare frequency domain data for inversion. The new method uses a particular type of left preconditioning that de-weights the influence of large phase jumps. Either the observed phase and modeled phase may be unwrapped individually or just their difference, the residual phase, may be unwrapped. The latter is preferred since the phase differences between adjacent data points will be smaller.

The procedure we use for phase unwrapping is inspired by a fundamental theorem of vector calculus, also called the Helmholtz Decomposition. The Helmholtz Decomposition can be used to decompose a vector field into a curl-free component and a divergence-free component. We are interested in the curl-free component only, so we do not require a precise Helmholtz decomposition. The curl-free component is the gradient of a scalar potential, and is a conservative field. A conservative field is a vector field for which line integrals between arbitrary points are path independent. We identify unwrapped residual phase with the scalar potential whose gradient is the conservative field of a Helmholtz decomposition.

We start by taking the gradient of the input wrapped phase, and adjusting by adding or subtracting 2π so that the result lies in the range [−π,+π]. This “adjusted phase” is also known as the “principal value” of the phase. Here “gradient” means the numerical derivative along the directions of source (up to 3 directions) and receiver (up to 3 directions), respectively. We can write the projection of the adjusted gradient of phase onto a conservative field as follows:

∇φᵣₑₛ=g Eqn. 22

where φᵣₑₛ is the unwrapped residual phase and g is the adjusted gradient of the wrapped phase, as explained above.

To calculate unwrapped phase, we discretize the gradient operator with respect to source and receiver coordinates and solve the overdetermined system shown in Eqn. 23 by least squares. In one embodiment, we find that a sparse QR factorization is a particularly effective method for solving this system of equations.

min∥∇φᵣₑₛ−g∥² Eqn. 23

This approach of projection onto a conservative field for phase unwrapping has difficulty at moderate frequencies much greater than 1 Hz. For nₛ sources and nᵣ receivers, the system of equation 23 will have nₛ*nᵣ rows for the adjusted gradient with respect to source coordinates, and nₛ*nᵣ rows for the adjusted gradient with respect to receiver coordinates. It is therefore twice overdetermined.

We found that shortcomings in phase unwrapping are related to large magnitudes of the entries of the adjusted gradient, and by weighting these large magnitude entries down, which has the effect of de-emphasizing their importance in the system of equations, we can significantly improve robustness. In an embodiment, the application of a diagonal left preconditioner whose entries are inversely proportional to the magnitude of the adjusted gradient greatly improves the performance of phase unwrapping at higher frequencies. Other types of preconditioners may also be used and fall within the scope of the present invention.

The new system of equations is shown in equation 24, where the k^{th} element of the left preconditioner W is inversely proportional to the magnitude of the components of the k^{th} element of the adjusted gradient raised to the power α.

min∥W[∇φᵣₑₛ−g]∥²

W_{k,s}=|g_{k,s}|^{-∝}

W_{k,s}=|g_{k,r}|^{-∝} Eqn. 24

In one embodiment, α may be set to 2.5.

We note that this phase unwrapping approach does not require integration or the specification of boundary conditions in order to obtain unwrapped phase from the principal value of the gradient of wrapped phase.

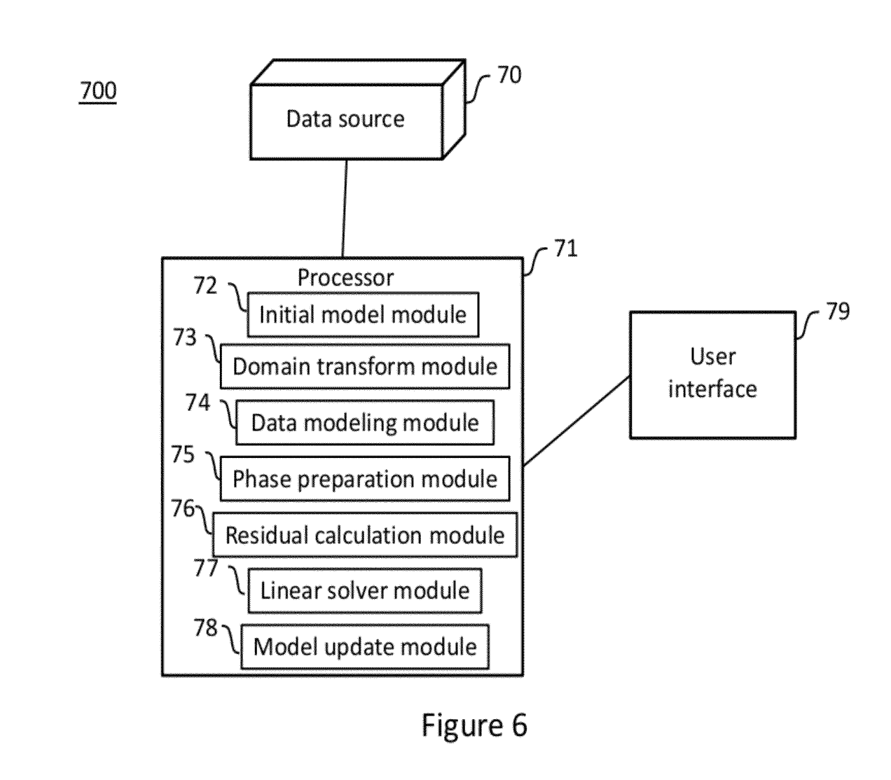

A system 700 for performing the method is schematically illustrated in FIG. 6. The system includes a data storage device or memory 70. The data storage device 70 contains recorded data and may contain an initial model. The recorded data may be made available to a processor 71, such as a programmable general purpose computer. The processor 71 is configured to execute an initial model module 72 to create an initial model if necessary or to receive the initial model from the data storage 70. The processor 71 is also configured to execute the domain transform module 73 for transforming recorded data into the frequency domain, the data modeling module 74 for forward modeling data based on the initial model, the phase preparation module 75 for phase unwrapping with a preconditioner, the residual calculation module 76 for performing step 52 or 65, the linear solver module 77 for performing step 53 or 66, and the model update module 78 for updating the model. The processor 71 may include interface components such as a user interface 79, which may include both a display and user input devices, and is used to implement the above-described transforms in accordance with embodiments of the invention. The user interface may be used both to display data and processed data products and to allow the user to select among options for implementing aspects of the method.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A computer-implemented method for determining properties of a subsurface region of interest from seismic data comprising:
a. obtaining actual seismic data representative of the subsurface region and an initial earth property model for the subsurface region;
b. performing forward modeling, using the initial earth property model, to create modeled seismic data with similar acquisition specifications as the actual seismic data;
c. calculating a residual between the actual seismic data and the modeled seismic data in a time or transform domain; and
d. inverting the residual to generate a model produced by non-linear model update components, wherein the performing forward modeling, calculating, and inverting steps are performed by a computer processor.

2. The method of claim 1 wherein the non-linear model update components are derived from an inverse scattering series of a forward modeling equation.

3. The method of claim 1 where the residual is expressed in terms of an unwrapped phase.

4. The method of claim 4 wherein the phase unwrapping comprises
a. taking a gradient of the phase portion,
b. adjusting the gradient to lie in the a principal [−π,+π] range to create an adjusted gradient,
c. setting the adjusted gradient equal to a discretization of the gradient applied to of the unwrapped phase portion, and
d. solving for the unwrapped phase portion by applying a preconditioner to the linear equations.

5. A system for determining properties of a subsurface region of interest from seismic data comprising:
a. a data source containing actual seismic data;
b. a processor configured to execute computer-readable code from computer modules, the computer modules comprising:
i. an initial model module configured to receive an initial model from the data source or generate the initial model;
ii. a domain transformation module to transform the actual seismic data into a frequency domain to generate frequency domain seismic data;
iii. a data modeling module to generate modeled seismic data from the initial model;
iv. a phase preparation module to phase unwrap the frequency domain seismic data;
v. a residual calculation module to calculate a residual wavefield;
vi. a linear solver module to solve the linear system for a perturbation in the properties of the subsurface region; and
vii. a model update module to update the initial model based on the perturbation; and
c. a user interface.

6. An article of manufacture comprising a computer readable medium having a computer readable code embodied therein, the computer readable program code adapted to be executed to implement a method for inverting actual data from an area of interest to determine physical properties of the area of interest, the method comprising:
a. obtaining actual seismic data representative of the subsurface region and an initial earth property model for the subsurface region;
b. performing forward modeling, using the initial earth property model, to create modeled seismic data with similar acquisition specifications as the actual seismic data;
c. calculating a residual between the actual seismic data and the modeled seismic data in a time or transform domain; and
d. inverting the residual to generate a model produced by non-linear model update components.
